(19) United States
(12) Patent Application Publication
(10) Pub. No.: US 2021/0152542 A1
(43) Pub. Date: May 20, 2021

(54) ACCESS TOKENS WITH SCOPE EXPRESSIONS OF PERSONAL DATA POLICIES

(71) Applicant: Hewlett-Packard Development Company, L.P., Spring, TX (US)

(72) Inventors: Galo Gimenez Palop, Boise, ID (US); Eduardo Argollo de Oliveira Dias, Vancouver, WA (US); Jennifer Leigh Schodowski, Vancouver, WA (US)

(73) Assignee: Hewlett-Packard Development Company, L.P., Spring, TX (US)

(21) Appl. No.: 17/047,491

(22) PCT Filed: Jun. 14, 2018
(86) PCT No.: PCT/US2018/037458

§ 371 Date: Oct. 14, 2020

(51) Int. Cl. H04L 29/06; G06F 21/62; G06F 9/451

(52) U.S. Cl. CPC H04L 63/0807; H04L 63/102; G06F 9/451; G06F 21/6245; H04L 63/20

(57) ABSTRACT

An example device includes a communications interface to communicate data with a network and a processor connected to the communications interface. The processor is to generate an access request and communicate the access request to an authorization service via the communications interface. The access request includes a requested scope of access to a resource available on the network. The processor is further to receive an access token from the authorization service. The access token contains a scope expression indicative of a personal data policy of an authorized scope of access to the resource. The processor is further to request access to the resource with the access token containing the scope expression indicative of the personal data policy.

### BACKGROUND

Computer systems collect and store various kinds of data. Users may provide personal information to a computer system for different reasons. Personal information may be required to use a computer-based service, such as a social network, an online banking service, a document storage service, and similar. A user may wish to store personal information, such as photographs, financial records, passwords, and the like at a computer system. As such, computer systems that store personal information often use various methodologies to limit access to personal information.

### BRIEF DESCRIPTION OF THE DRAWINGS

FIG. 1 is a block diagram of an example device with an access token containing a scope expression indicative of a personal data policy.

FIG. 2 is a block diagram of an example system with an access token containing a scope expression indicative of a personal data policy.

FIG. 3 is a diagram of example communications in the example system of FIG. 2.

FIG. 4 is a block diagram of an example system with a policy engine to evaluate personal data policy contained within an access token.

FIG. 5 is a diagram of example communications in the example system of FIG. 4.

FIG. 6 is a block diagram of an example device to execute policy on a request with an access token containing a scope expression indicative of a personal data policy.

FIG. 7 is a block diagram of an example authorization server to generate an access token containing a scope expression indicative of a personal data policy.

### DETAILED DESCRIPTION

Computer access methodologies may include the use of tokens to facilitate exchange of data between two endpoints, such as a client application and a resource server. OAuth 2.0 is an example of an access delegation methodology that uses tokens.

A scope parameter of a token, such as an OAuth 2.0 token, may be augmented to enable enforcement of personal data policies by network infrastructure. This may be used to control access to personal information.

A token is granted to a client application when the application is to access a resource via a network. In an example scenario, the client application is operated by a user who also owns or controls information at the resource. The client application may ask the user to authorize the application's access to the resource. Access to the resource is controlled by a token that is granted to the application when authorized. The token may include a scope parameter that specifies the type of access, such as read access, write access, and similar. That is, the application may be authorized to read and/or write data at the resource.

The augmented scope parameter specifies a personal data policy of a scope of access by the application to the resource. Example personal data policies include personal identifiable information, personal credit information, personal health information, personal financial information, and similar. Hence, tokens containing augmented scope may authorize the application to access to these types of information.

Network infrastructure connecting the client application and the resource may inspect an augmented scope parameter in a token of a request and enforce personal data policy on the request, irrespective of any policy enforcement that may or may not be implemented at the resource. This may reduce or eliminate the need for an individual resource to implement personal data policy and may allow for centralized personal data policy management and enforcement.

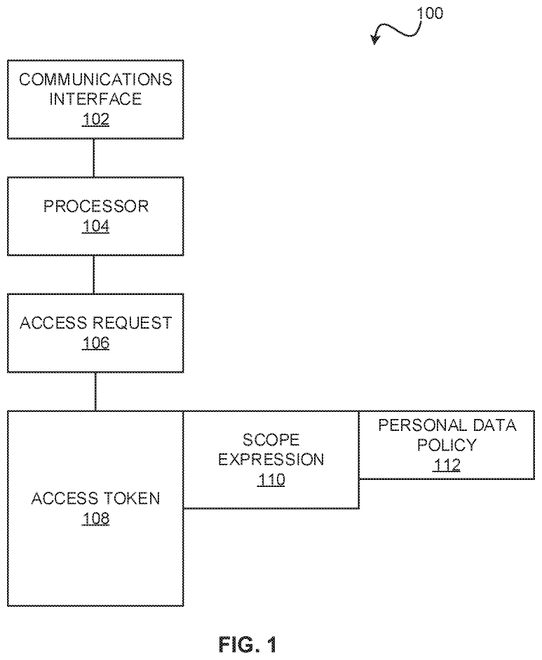

FIG. 1 shows an example device 100. The device 100 may be an electronic device, such as a desktop computer, notebook computer, tablet computer, smartphone, or the like. The device 100 may be considered a client device that may be operated by a user.

The device 100 includes a communications interface 102 and a processor 104 connected to the communications interface 102.

The communications interface 102 allows the device 100 to communicate data with a network. The communications interface 102 may include a wired or wireless interface, such as an Ethernet adaptor, Wi-Fi transceiver, or similar.

The processor 104 may include a central processing unit (CPU), a microcontroller, a microprocessor, a processing core, a field-programmable gate array (FPGA), and/or similar device capable of executing instructions. The processor 104 may cooperate with a non-transitory machine-readable medium that may be an electronic, magnetic, optical, and/or other physical storage device that encodes processor-executable instructions. The machine-readable medium may include, for example, random access memory (RAM), read-only memory (ROM), electrically-erasable programmable read-only memory (EEPROM), flash memory, a storage drive, an optical disc, and/or similar.

The processor 104 may execute an application that connects to a network resource via the communicated interface 102.

The processor 104 may generate an access request 106 for access to a resource available on the network. The user of the device 100 may be the owner of the resource. The resource may contain personal data, such as personal identifiable information, personal credit information, personal health information, personal financial information, or similar.

The access request 106 may include a requested scope of access to the resource. For example, the processor 104 may execute a client application that is to connect to a document resource, and a scope of access may include read and write access to documents stored at the document resource.

The processor 104 may communicate the access request to an authorization service via the communications interface 102, so as to establish the authorization of the device 100 to access the resource. A user of the device 100 may provide a credential to the authorization service to authorize the device 100.

The processor 104 may receive an access token 108 from the authorization service to grant access to the resource. The access token 108 may contain a scope expression 110 indicative of a personal data policy 112 of an authorized scope of access to the resource. The processor 104 may then request access to the resource with the access token 108 containing the scope expression 110 indicative of the personal data policy 112.

The access token 108 may accord with OAuth 2.0. The access token 108 may be a JavaScript Object Notation (JSON) Web Token or JWT.

The scope expression 110 establishes a scope of access to the resource and the relevant personal data policy 112 to govern access to the resource. Scope may limit access to target data, such as a user profile, a document, a file, an image, and the like and the type of operations that may be carried out on target data, such as read, write, modify, share, delete, and similar. Scope may limit the type of user (e.g., a normal user, an administrator, etc.) that may access a resource. The personal data policy 112 may define the target data in terms of personal data. That is, the personal data policy 112 may establish whether or not the target data contains personal data and the nature of the personal data contained.

The scope expression 110 may be generated by augmenting a scope with a policy string. For example, the personal data policy 112 may be indicated by a string such as “personal”, “personal_identifiable”, “health”, “financial” for respective policies. The policy string may be selected from a set of predefined policy strings indicative of different personal data policies. That is, a finite set of predefined policy strings may be established and a given scope expression 110 may contain string selected from the set.

Scope expressions 110 may be normalized to include policy information, such as personal data policy 112, that may be managed by a generic policy engine framework. As such, the semantics of the scope may be understood outside of an application and may be interpreted and acted upon by network infrastructure that is independent of the functionality of the application and its resource.

For example, a finite set of predefined policy strings “personal”, “personal_identifiable”, “health”, and “financial” may be used to indicate personal information, personal identifiable information, personal health information, and personal financial information, respectively. A selected policy string may augment a scope, which may itself be a string, such as “read”, “write”, and “modify”.

A scope expression 110 may use a schema, such as:

[scope][separator][policy string]

in which a scope is concatenated with a policy string using a predetermined separator string, such as “/” or other symbol. With the example policy strings above, a scope that allows the reading of data that may contain health information may be expressed as:

read/health

and a scope that allows write access to data that may contain personal identifiable information may be expressed as:

write/personal_identifiable

Another example schema for scope expression is:

[service URL]/[resource].[scope]/#[namespace]/[version]/[policy string]

where different scopes may be specified for different resources as different locations (e.g., service uniform resource locator or URL). A personal data policy 112 may be expressed as a namespace, version, and policy string. Using a namespace may help avoid collisions, for example, in the event that different authorities use the same policy string. A version may be used to update a given personal data policy as regulations and other circumstances may change.

With the example policy strings above, a scope of this example schema that allows the reading of documents that may include personal information may be expressed as:

http://sdm.api.hp.com/documents.read#um:policy:data.policy.hp.com/v1/personal

Similarly, a scope that allows writing to a profile that may contain personal identifiable information may be expressed as:

http://sdm.api.hp.com/profile.write#um:policy:data.policy.hp.com/v2/personal_identifiable

In an OAuth 2.0 token, the value of a scope parameter may be expressed as a list of space delimited, case-sensitive strings. An example OAuth2 token scope string with personal data policies is:

http://sdm.api.hp.com/documents.read#um:policy:data.policy.hp.com/v1/personal

http://sdm.api.hp.com/profile.wrte#um:policy:data.policy.hp.comtv2/personal_identifiable

A scope expression 110 that indicates a personal data policy 112 according to a common semantic model, as discussed above, allows personal data policy decisions to be handled outside of the application and its resource, such as by infrastructure of the network that connects the application to its resource. Computational efficiency in policy enforcement may be increased as compared to relying on individual applications and/or resources to enforce policy. For example, a router that inspects tokens for personal data policy and filters requests that concern personal information may be more efficient than dozens of resources served by the router each inspecting such tokens and applying individual filtering.

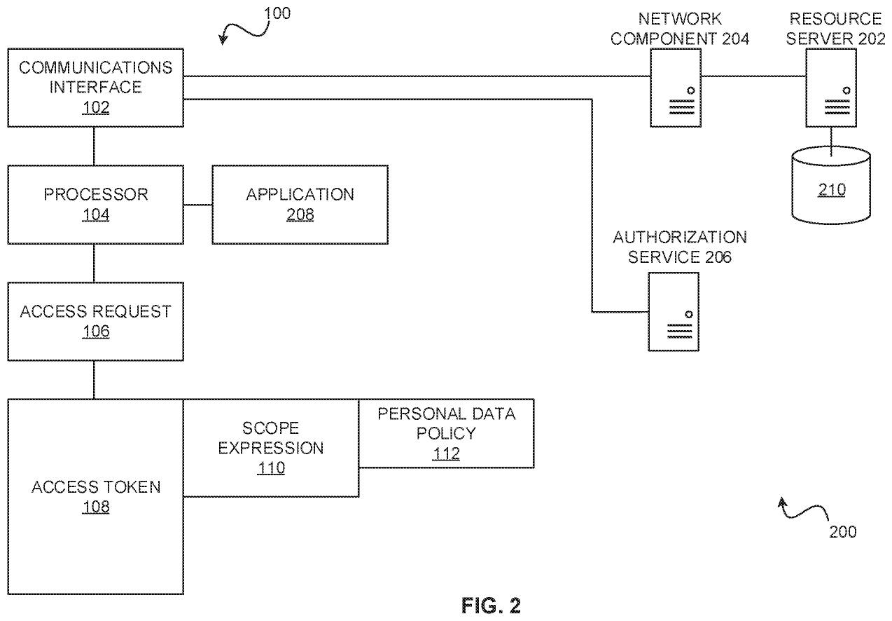

FIG. 2 shows an example system 200. The system 200 includes a device 100, a resource server 202, a network component 204, and an authorization service 206, such as an OAuth 2.0 service. The network component 204 may include a gateway, router, switch, or similar component of network infrastructure between the device 100 and the resource server 202. Features and aspects described elsewhere herein may be used with the system 200, and related description may be referenced, with like reference numerals denoting like components.

The device 100 includes a communications interface 102 to connect to the resource server 202, the network component 204, and the authorization service 206 via a network. The device 100 may include an application 208 that is executable by its processor 104.

The application 208 may be referred to as a client application and may interact with the resource server 202, which may store data 210 that may include personal data, to provide functionality to a user of the device 100. An example application is a document storage application that stores a user's documents and other information at the resource server 202. Numerous other example applications are possible, such as a social network application, an online banking application, a photo sharing application, others mentioned elsewhere herein, and the like.

The authorization service 206 is to provide authorization to the application 208 to access a resource at the resource server 202. Authorization may be made in response to an access request 106 received from the device 100 and may include an access token 108. The authorization service 206 may provide an access token 108 that contains a scope expression 110 indicative of a personal data policy 112 to govern access to the requested resource. The authorization service 206 may grant or deny authorization according to any suitable methodology and may require a user of the application 208 to provide a credential or other user identity information.

The authorization service 206 may demand different credentials for different requested scopes in an access request 106. For example, a requested scope to write to document may require a credential of higher security than a requested scope to read the document.

The authorization service 206 provide a personal data policy 112 within an access token 108 according to various methodologies. The authorization service 206 may assign a personal data policy 112 based on the requesting application. That is, an application and its resource may be assigned a particular personal data policy 112. A social network application may be assigned a personal data policy 112 of personal identifiable information, while an online banking application may be assigned a personal data policy 112 of personal financial information. An access request 106 communicated to the authorization service 206 may indicate a requested personal data policy 112, and the authorization service 206 may respond by providing an access token indicating the same personal data policy 112.

The device 100 may include the access token 108 in a request to the resource server 202. Subsequent requests may use access tokens 108.

The network component 204 may enforce policy on requests to the resource server 202. The personal data policy 112 contained in a particular request may be referenced by the network component 204 to allow, deny, log, or take other action in relation to the particular request to the resource server 202. The network component 204 may include a policy engine or may be connected to a policy engine.

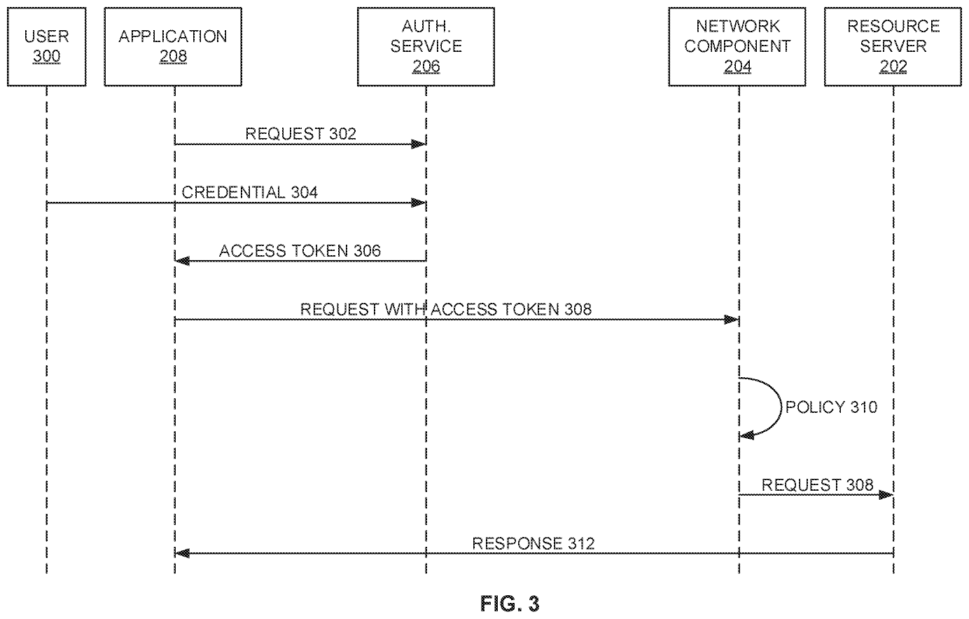

FIG. 3 illustrates example communications in a system 200, in which policy is applied to a request with an access token containing a scope expression indicative of a personal data policy.

An application 208 is to communicate with a resource server 202. A user 300 of the application 208 may be requested to authorize the application 208 to access a resource of stored at the resource server 202.

The application 208 may submit a request 302 to an authorization service 206. The request 302 may include a requested scope of access to a resource to which the application 208 is to access. For example, if the application 208 is a document storage application, then the request 302 may include a request to read a document from the resource server 202.

The user 300 may provide a credential 304 to the authorization service 206 to grant authorization to the application 208. Examples of credentials include a username and password, a digital certificate, a biometric, and the like. The user 300 thereby authorizes the application 208 to access the resource according to the requested scope.

The authorization service 206 may respond with an access token 306 which may encode the granted scope of access to the resource. The access token may contain a scope expression indicative of a personal data policy to govern access to the resource.

The application 208 receives the access token and communicates with the resource server 202 using the access token. The application 208 may send a request 308 with the access token to the resource server 202. The request 308 may be conveyed by network infrastructure, such as a network component 204.

Policy may be enforced 310 on the request by the network component 204. To enforce policy, the scope expression in the access token may be inspected and any indication of personal data policy, such as a policy string, may be evaluated. For example, requests 308 that relate to personal information may be subject to policy different from requests that do not relate to personal information. Different types of personal information, such as health information and financial information, may be subject to different policy. Enforcement of policy by the network component 204 is based on personal data policy contained in the token, irrespective of any meaning ascribed to the personal data policy contained in the token by the resource server 202.

Other information contained in the request 308 or in the access token may be used to evaluate and enforce policy. For example, location information present in the request may be considered with an indication of personal data policy in the access token. Requests pertaining to personal information received from an application located outside a particular region may be denied, whereas requests pertaining to personal information received from within the particular region may be allowed. This may allow for communication of personal information to be controlled based on geographic location. For example, tokens associated with an online banking application may contain a personal data policy that identifies financial information. Requests including such tokens may be denied when the location of the source of the request differs from an allowed location, such as the region in which the bank operates. Requests originating from outside of such region may be denied by network infrastructure.

A request 308 that is not denied is communicated to the resource server 202, which responds 312 to the application 208 with the requested information.

Tokens may be granted and refreshed for any number of requests as the application 208 communicates with the resource server 202. Policy may be applied to each request that contains an access token by evaluating any personal data policy expressed in the access token. Network infrastructure, such as the network component 204, may enforce personal information policy irrespective of any such policy enforcement implemented at the resource server 202. A common network component 204 may reduce or eliminate the need for multiple resource servers to individually implement personal information policy.

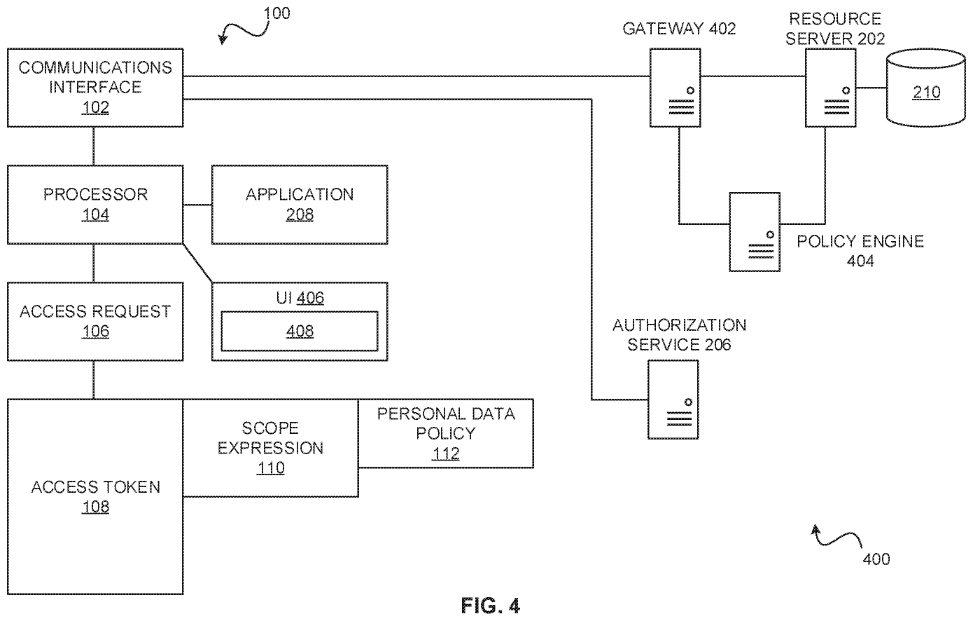

FIG. 4 shows an example system 400. The system 400 includes a device 100, a resource server 202, a gateway 402, a policy engine 404, and an authorization service 206. Features and aspects described elsewhere herein may be used with the system 400, and related description may be referenced, with like reference numerals denoting like components.

The gateway 402 may process communications between the device 100 and the resource server 202. The gateway 402 may include an application programming interface (API) gateway. The gateway 402 may authorize requests by the device 100 to the resource server 202 and validate access tokens contained in requests. The gateway 402 may communicate with the policy engine 404.

The policy engine 404 executes policy decisions to determine how requests should be handled, and in particular, to enforce a personal data policy 112 that may be expressed in an augmented scope expression 110 of an access token 108.

In addition, the device 100 may further include a user interface 406, such as a display device, a touchscreen, or similar. The processor 104 may display a representation 408 of the personal data policy 112 at the user interface 406. The personal data policy 112 displayed may be as requested in an access request 106 or as authorized in an access token 108. An example of a representation 408 of the personal data policy 112 is a text string that indicates to the user the type of information being requested. For example, the representation 408 may include text such as “This application is requesting access to your personal financial information.”

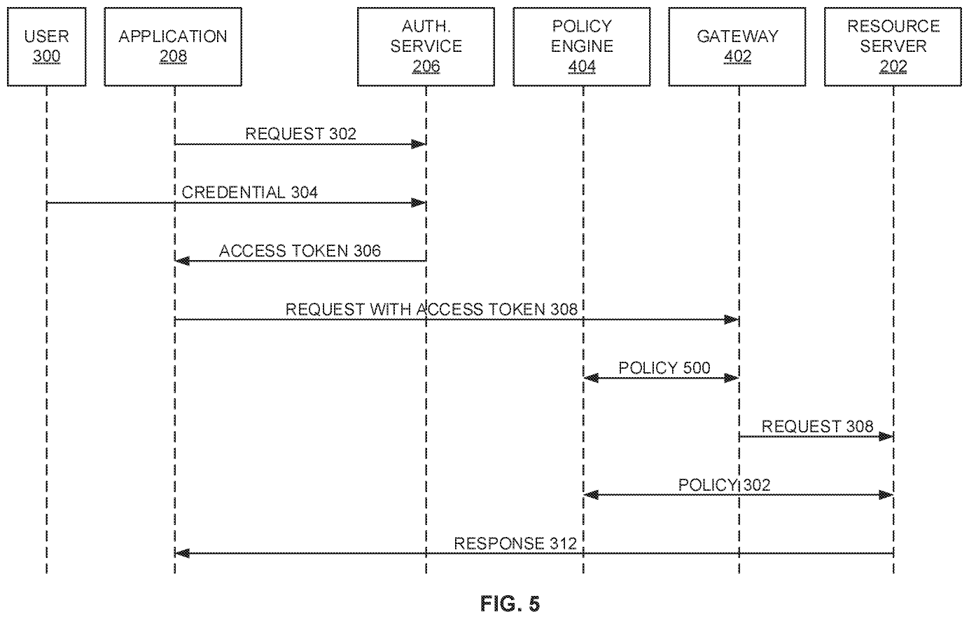

FIG. 5 illustrates example communications in a system 400, in which policy is applied to a request with an access token containing a scope expression indicative of a personal data policy. The description for FIG. 3 may be referenced, with like reference numerals denoting like components, and related discussion will not be repeated here.

A request 308 containing an access token may be sent by an application 208 to a resource server 202 after the application 208 is authorized by the user 300. The access token may contain a scope expression indicative of a personal data policy.

A gateway 402 may intercept the request 308 and conduct a policy transaction 500 with a policy engine 404. Policy may be enforced on the basis of a personal data policy present in the access token. The gateway 402 may allow, deny, or take other action on a request 308 as indicated by the policy engine 404.

When a request 308 is allowed, it is communicated to the resource server 202. The resource server 202 may also communicate with the policy engine 404 to conduct a policy transaction 502 on the basis of the request 308 and the personal data policy present in the access token. The resource server 202 may implement different policy differently from the gateway 402. For example, the resource server 202 may consider a user's access rights to a particular resource, whereas the gateway 402 may consider the personal data policy present in the access token.

Accordingly, the resource server 202 may respond 312 to the application 208 with the requested information.

In some examples of the system 400, policy enforcement may be distributed across a plurality of gateway nodes 402. For example, a service mesh may be used. A gateway node 402 may implement a policy engine or agent. Providing personal data policy information within access tokens allows for increased efficiency in policy evaluation by such a system. The cost of policy evaluation on network performance may be significantly reduced.

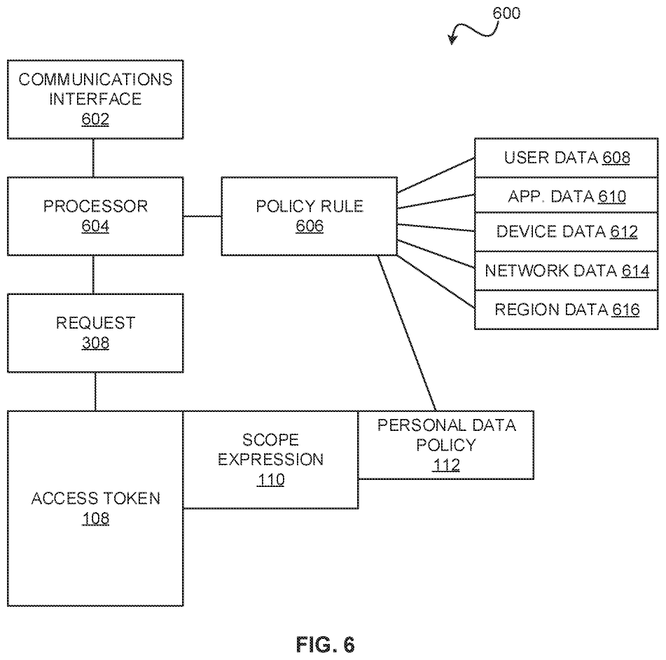

FIG. 6 shows an example network component 600 to execute policy on a request having an access token containing a scope expression indicative of a personal data policy. Features and aspects described elsewhere herein may be used with the network component 600, and related description may be referenced, with like reference numerals denoting like components.

The network component 600 may be a component of network infrastructure, such as a router, switch, gateway, or similar. The network component 600 may be an example of a gateway 402, discussed above, to apply policy decisions to requests made by a client application to a resource server.

The network component 600 may include a communications interface 602 and a processor 604 connected to the communications interface 602. Suitable communications interfaces and interfaces are described elsewhere herein.

The network component 600 may intercept or otherwise obtain requests 308 via the communications interface 602. A request 308 may be transmitted by a client application to a resource server. The request 308 may include an access token 108 containing a scope expression 110 augmented with personal data policy 112.

The processor 604 may execute policy decisions on the request 308 by applying a policy rule 606. Any number of policy rules 606 may be implemented to cause the processor 604 to alloy, deny, log, or take other action on requests 308. A policy rule 606 may reference information associated with the request 308 or corresponding access token 108, such as user data 608 of a user of the client application that originated the request, application data 610 of the client application that originated the request, device data 612 of the client device executing the client application, network data 614 associated with the client device or application, region data 616 associated with the client device or application, a personal data policy 112 of the scope expression 110 of the access token 108, and similar. Examples of user data 608 include a username, an email address, a user account identifier, and the like. Examples of application data 610 include an application name, an application identifier, an application version, and the like. Examples of device data 612 include a device identifier, a media access control (MAC) address, an International Mobile Station Equipment Identity (IEMI), and the like. Examples of network data 614 include a network address, an internet protocol (IP) address, a network protocol, a network name, a network type, and similar. Examples of region data 616 include a legal zone or jurisdiction in which the request originated, a country, a state/province, and similar.

A personal data policy 112 may include a policy string selected from a set of predefined policy strings indicative of different personal data policies. Such normalized policy strings may indicate personal data policies such as personal identifiable information, personal credit information, personal health information, personal financial information, and similar.

In some examples, a policy rule 606 is set to limit access to personal information by filtering requests 308 based on personal data policy 112. Additional data 608-614 may further be used to filter requests 308.

A component of network infrastructure applying a policy rule 606 to enforce personal data policy 112, as discussed herein, may reduce or eliminate the need to rely on subjective human judgement when limiting access to personal information. That is, reliance subjective interpretation of a personal information policy made by a human may be replaced by network infrastructure execution of a policy rule 606 on an explicit personal data policy 112 contained in an access token 108.

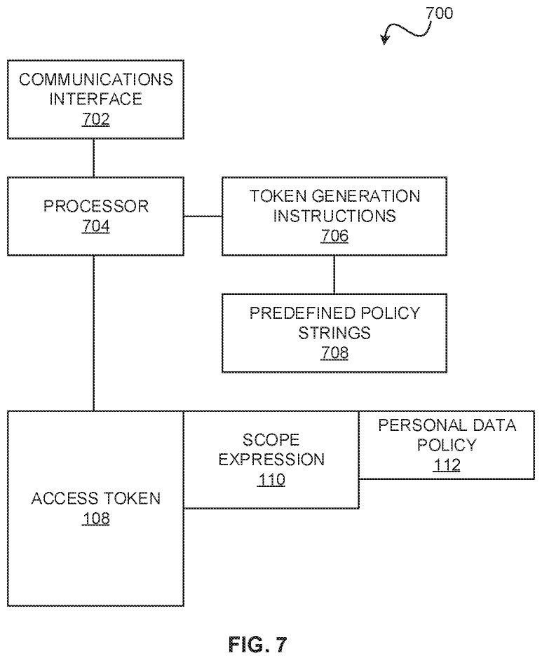

FIG. 7 shows an example authorization server 700 to generate an access token containing a scope expression indicative of a personal data policy. Features and aspects described elsewhere herein may be used with the authorization server 700, and related description may be referenced, with like reference numerals denoting like components.

The authorization server 700 may implement an authorization service, such as the authorization service 206, described elsewhere herein.

The authorization server 700 may include a communications interface 702 and a processor 704 connected to the communications interface 702. Suitable communications interfaces and interfaces are described elsewhere herein.

The authorization server 700 may include token generation instructions 706 that are executable by the processor 704. The token generation instructions 706 may generate access tokens 108. An access token 108 may be generated in response to a user of a client application providing a credential for a resource access request made by the client application. The access token 108 may be generated to contain a scope expression 110 indicative of a personal data policy 112 to be applied to the access of the client application to the resource.

The token generation instructions 706 may assign a personal data policy 112 based on the requesting application, based on a requested personal data policy 112, or using a similar methodology, some of which are described elsewhere herein.

The authorization server 700 may store a set of predefined policy strings 708, such as “personal”, “personal_identifiable”, “health”, “financial”, or similar text strings as described elsewhere herein, for respective personal data policies. The token generation instructions 706 may select a policy string from the predefined policy strings 708 when generating an access token 108. The token generation instructions 706 may insert the selected policy string into a scope expression 110 of the access token 108.

In view of the above, it should be apparent that a scope of a token, such as an OAuth 2.0 token, may be augmented to specify a personal data policy. An authorization framework, such as an OAuth 2.0 framework, applications and their network-based resources, and network infrastructure may be provided with centralized policy management and enforcement. Computational efficiency may be gained by having personal data policy enforced by network infrastructure.

It should be recognized that features and aspects of the various examples provided above may be combined into further examples that also fall within the scope of the present disclosure.

1. A device comprising:
a communications interface to communicate data with a network; and
a processor connected to the communications interface, the processor to generate an access request and communicate the access request to an authorization service via the communications interface, the access request including a requested scope of access to a resource available on the network, the processor further to receive an access token from the authorization service, the access token containing a scope expression indicative of a personal data policy of an authorized scope of access to the resource, the processor further to request access to the resource with the access token containing the scope expression indicative of the personal data policy.

2. The device of claim 1, wherein the scope expression augments a scope with a policy string that is selected from a set of predefined policy strings indicative of different personal data policies.

3. The device of claim 2, wherein the different personal data policies include two or more of personal identifiable information, personal credit information, personal health information, and personal financial information.

4. The device of claim 1, wherein the access token is an OAuth 2.0 token.

5. The device of claim 1, further comprising a user interface, wherein the processor is further to display a representation of the personal data policy at the user interface.

6. A network component comprising:
a communications interface to communicate data with a network; and
a processor connected to the communications interface, the processor to enforce a personal data policy on a request received via the communications interface, the request including an access token generated by an authorization service to provide access by a client application to a resource via the network, the access token containing a scope expression indicative of the personal data policy.

7. The network component of claim 6, wherein the processor is to allow or deny the request based on the scope expression indicative of the personal data policy.

8. The network component of claim 7, wherein the processor is to allow or deny the request further based on a region of the request.

9. The network component of claim 6, wherein the processor executes a policy rule to evaluate the personal data policy.

10. The network component of claim 6, wherein the personal data policy includes a string that is selected from a set of predefined strings indicative of different personal data policies.

11. An authorization server comprising:
a communications interface to communicate data with a network; and
a processor connected to the communications interface, the processor to generate an access token in response to a request received from a client application via the network, the request including a requested scope of access by the client application to a resource available on the network, the processor further to generate the access token to contain a scope expression indicative of a personal data policy of an authorized scope of access to the resource, the processor further to communicate the access token to the client application via the network.

12. The authorization server of claim 11, wherein the scope expression augments a scope with a policy string indicative of the personal data policy.

13. The authorization server of claim 12, wherein the processor is to select the policy string from a set of predefined policy strings indicative of different personal data policies.

14. The authorization server of claim 12, wherein the processor is to insert the policy string into the scope expression of the access token.

15. The authorization server of claim 11, wherein the access token is an OAuth 2.0 token.
